(19) United States
(12) Patent Application Publication
(10) Pub. No.: US 2023/0381563 A1
(43) Pub. Date: Nov. 30, 2023

(54) Threat-Based Fire Suppression Apparatus, System, and Method

(71) Applicant: The Boeing Company, Chicago, IL (US)

(72) Inventors: Brandon W. Freyling, Mukilteo, WA (US); Alfred R. Carlo, Bothell, WA (US)

(21) Appl. No.: 17/825,002

(22) Filed: May 26, 2022

(51) Int. Cl. A62C 37/40; A62C 3/08; A62C 3/10; A62C 3/02

(52) U.S. Cl. CPC A62C 37/40; A62C 3/08; A62C 3/10; A62C 3/0292

(57) ABSTRACT

Fire suppression systems are disclosed for contained environments within large structures, with the systems configured to detect one or more fire threat condition types at one or more fire threat locations with the system delivering a selected fire suppressant flow in response to a detected fire threat condition at a detected fire threat location within the contained environment. communication with a plurality of fire suppressant types that are releasable from centralized supplies

### TECHNOLOGICAL FIELD

The present disclosure relates generally to the field of fire suppression. More specifically, the present disclosure relates to the field of fire suppression in contained environments, including contained environments within structures.

### BACKGROUND

Fire suppression within structures has been accomplished by providing localized systems to large structures, with the systems designed to ameliorate or eliminate a fire threat. Economics often dictate that fire suppression systems provided to large systems, typically, employ a fire suppression agent that can be suitable for most, but not all, fire threat types. Further, fire suppression agent supplies for fire suppression systems that are provided to large structures typically reside in locations that are proximate to a location within a structure where a fire threat can occur.

Unless explicitly identified as such, no statement herein is admitted as prior art merely by its inclusion in the Technological Field and/or Background section.

### SUMMARY

Present aspects are directed to threat-based fire suppression apparatuses, systems and methods incorporated into large structures for the purpose of suppressing and/or eliminating fires and threats of fires within contained environments within large structures. According to present aspects, characteristics of a fire threat are detected at a fire threat location by a fire threat detector type for purposes of determining a fire threat type, a fire suppressant type is selected for use against the fire threat type from among a plurality of fire suppressant types and delivered to the fire threat location. According to further present aspects, multiple fire threat types at multiple fire threat locations and multiple fire threat types at a single fire threat location can be determined concurrently and/or sequentially, with separate and differing fire suppressant types delivered to individual fire threat locations concurrently and/or sequentially to suppress detected fire threat types.

According to a present aspect, a system for suppressing a detected fire threat in a contained environment within a structure is disclosed, with the system including a plurality of detectors, with the plurality of detectors comprising a plurality of detector types, each of the plurality of detector types configured to detect a fire threat condition in a fire threat location within the structure, and with the plurality of detector types further comprising differing detector types. According to present aspects, the system further includes a processor, with the processor in communication with at least one of the plurality of detectors, at least one controller, with the controller configured to receive a signal from: at least one of the processor and at least one of the plurality of detectors. The system further includes a plurality of fire suppressant types, with the plurality of fire suppressant types differing from one another, and with each of the plurality of fire suppressant types configured to be housed in a plurality of separate fire suppressant type supplies, and with each of the plurality of separate fire suppressant type supplies in communication with the at least one controller. The present systems further include a plurality of dispensers, with at least one of the plurality of dispensers in communication with at least one of the plurality of separate fire suppressant type supplies, and wherein at least one of the plurality of dispensers is configured to release the fire suppressant type delivered to the at least one of the plurality of dispensers in response to selected fire threat condition detected at the selected fire threat location.

In another aspect, at least one of the plurality of dispensers is in communication with more than one of the plurality of fire suppressant type supplies.

In another aspect, the differing detector types are selected from the group consisting of a heat detector, a smoke detector, a flame detector, a temperature change detector, and combinations thereof.

In a further aspect, the contained environment includes at least one of: a passenger compartment, a monument, a storage compartment, a crew compartment, an engine compartment, a battery compartment, and a cockpit.

In another aspect, at least one of the plurality of separate fire suppressant supplies is located remotely from the fire threat location.

In another aspect, the fire threat location is located within a contained environment within the structure.

In a further aspect, a detected fire threat includes a detected multi-type fire threat.

In another aspect, a structure including a system for suppressing a detected fire threat in a contained environment within a structure is disclosed, with the system including a plurality of detectors, with the plurality of detectors comprising a plurality of detector types, each of the plurality of detector types configured to detect a fire threat condition in a fire threat location within the structure, and with the plurality of detector types further comprising differing detector types. According to present aspects, the system further includes a processor, with the processor in communication with at the plurality of detectors, at least one controller, with the controller configured to receive a signal from at least one of the processor and at least one of the plurality of detectors. The system further includes a plurality of fire suppressant types, with the plurality of fire suppressant types differing from one another, and with each of the plurality of fire suppressant types configured to be housed in a plurality of separate fire suppressant type supplies, and with each of the plurality of separate fire suppressant type supplies in communication with the at least one controller. The present systems further include a plurality of dispensers, with at least one of the plurality of dispensers in communication with at least one of the plurality of separate fire suppressant type supplies, and wherein at least one of the plurality of dispensers is configured to release the fire suppressant type delivered to the at least one of the plurality of dispensers in response to selected fire threat condition at the detected at the selected fire threat location.

In another aspect, each of the detector types is configured to detect at least one of a first fire threat condition and a subsequent fire threat condition in at least one fire threat location located within the structure, with the plurality of detector types further including differing detector types, and wherein at least one of the plurality of dispensers is configured to release at least one of plurality of fire suppressant types delivered to the at least one of the plurality of dispensers in response to at least one of a detected first fire threat condition and a subsequent fire threat condition in the fire threat location.

In a further aspect, the structure is a building.

In another aspect, the structure is an aircraft.

In a further aspect, the structure is a vehicle, with the vehicle selected from the group consisting of a crewed aircraft, an uncrewed aircraft, a crewed spacecraft, an uncrewed spacecraft, a crewed rotorcraft, an uncrewed rotorcraft, a crewed terrestrial vehicle, an uncrewed terrestrial vehicle, a crewed surface water borne vehicle, an uncrewed waterborne vehicle, a crewed sub-surface water borne vehicle, an uncrewed sub-surface water borne vehicle, a satellite, and combinations thereof.

According to further present aspects, a method for detecting and responding to a detected fire threat in a contained environment within a large structure is disclosed, with the method including detecting a first fire threat condition at a first fire threat location within a structure, with the structure comprising at least one contained environment, with the first fire threat condition detected by at least one fire threat detector type, with the at least one fire threat detector type configured to send a first fire threat signal to a system processor, with the system processor in communication with at least one controller, with the at least one controller in communication with a plurality of fire suppressant types, with each of the plurality of fire suppressant types housed within a corresponding and separate fire suppressant type supply, and with each of the corresponding fire suppressant type supply positioned at a corresponding fire suppressant type supply location within the structure. The method further includes determining the first fire threat location within the structure, with the structure comprising at least one contained environment, selecting at least one of the plurality of fire suppressant types from the corresponding and separate fire suppressant type supply to form a selected fire suppressant type in response to the first fire threat condition detected by the at least one fire threat detector type, sending a first fire threat condition signal from the detector to at least one of the system processor and the system controller, and releasing a selected amount of the at least one of the plurality of selected fire suppressant types from the selected fire suppressant type supply to form a selected fire suppressant type flow in response to the first fire threat condition signal. The method further includes directing the selected fire suppressant type flow to at least one fire suppressant delivery device, releasing the selected fire suppressant type flow from the at least one fire suppressant delivery device, directing the selected fire suppressant type flow to the first fire threat location, storing each of the plurality of fire suppressant types within a corresponding separate and centralized fire suppressant type supply.

In another aspect a method further includes detecting a subsequent fire threat condition at a subsequent fire threat location within the structure, with the subsequent fire threat condition detected by the at least one fire threat detector type, with the at least one fire threat detector type configured to send a subsequent fire threat signal to the at least one of the system processor and the controller, with the system processor in communication with at least one controller, with the at least one controller in communication with at least two of the plurality of fire suppressant types, each of the at least two fire suppressant types housed within an associated fire suppressant type supply, determining the subsequent fire threat location within the structure, with the structure comprising at least one contained environment, selecting at least one of the plurality of fire suppressant types to form a selected fire suppressant type, with the selecting in response to the subsequent fire threat condition detected by the at least one fire threat detector type, sending a subsequent fire threat condition signal from the detector to at least one of the system processor and the system controller, releasing a selected amount of the selected fire suppressant type from the selected fire suppressant type supply to form a selected fire suppressant type flow in response to the subsequent fire threat signal, directing the selected fire suppressant type flow to at least one fire suppressant delivery device, releasing the selected fire suppressant type flow from the at least one fire suppressant delivery device, and directing the selected fire suppressant type flow to the subsequent fire threat location.

In another aspect, a method further includes delivering an amount of a selected fire suppressant type to the subsequent fire threat location from the fire suppressant type supply in response to the first fire threat signal.

In a further aspect, a method further includes delivering an amount of a selected fire suppressant type from the fire suppressant type supply in response to the subsequent fire threat signal.

In another aspect, a method further includes delivering concurrently a plurality of fire suppressant types to a first fire threat location, with the plurality of fire suppressant types each comprising a different fire suppressant type in response to the first fire threat signal.

In another aspect, a method further includes delivering sequentially a plurality of fire suppressant types to a first fire threat location, the plurality of fire suppressant types each comprising a different fire suppressant type in response to the first fire threat signal.

In a further aspect, a method further includes delivering concurrently a plurality of fire suppressant types to at least one of the first fire threat location and the subsequent fire threat location, with the plurality of fire suppressant types each comprising a different fire suppressant type in response to at least one of the first fire threat signal and the subsequent fire threat signal.

In another aspect, a method further includes delivering sequentially a plurality of fire suppressant types to at least one of the first fire threat location and the subsequent fire threat location, with the plurality of fire suppressant types each comprising a different fire suppressant type, and with the different fire suppressant type selected in response to at least one of the first fire threat signal and the subsequent fire threat signal.

In a further aspect, the plurality of fire suppressant types comprise at least one of a solid fire suppressant, at least one of a liquid fire suppressant, a at least one of gaseous fire suppressant, and combinations thereof.

In another aspect, the structure is selected from the group consisting of a vehicle and a building.

According to present aspects an apparatus for suppressing a detected fire threat in a contained environment within a structure, with the apparatus including a plurality of detectors, with the plurality of detectors comprising a plurality of detector types, and with each of the plurality of detector types configured to detect a fire threat condition in a fire threat location within the structure, the plurality of detector types further comprising differing detector types. The apparatus further includes a processor, with the processor in communication with at the plurality of detectors, at least one controller, with the controller configured to receive a signal from at least one of the processor and at least one of the plurality of detectors, a plurality of fire suppressant types, with the plurality of fire suppressant types differing from one another, with each of the plurality of fire suppressant types configured to be housed in a plurality of separate fire suppressant type supplies, with each of the plurality of separate fire suppressant type supplies in communication with the at least one controller, and a plurality of dispensers, with at least one of the plurality of dispensers in communication with at least one of the plurality of separate fire suppressant type supplies, and wherein at least one of the plurality of dispensers configured to release the fire suppressant type delivered to the at least one of the plurality of dispensers in response to selected fire threat condition at the selected fire threat location.

In another aspect, at least one of the plurality of dispensers is in communication with more than one of the plurality of fire suppressant type supplies.

In a further aspect, a vehicle includes an apparatus for suppressing a detected fire threat in a contained environment within a structure, with the apparatus including a plurality of detectors, with the plurality of detectors comprising a plurality of detector types, and with each of the plurality of detector types configured to detect a fire threat condition in a fire threat location within the structure, the plurality of detector types further comprising differing detector types. The apparatus further includes a processor, with the processor in communication with at the plurality of detectors, at least one controller, with the controller configured to receive a signal from at least one of the processor and at least one of the plurality of detectors, a plurality of fire suppressant types, with the plurality of fire suppressant types differing from one another, with each of the plurality of fire suppressant types configured to be housed in a plurality of separate fire suppressant type supplies, with each of the plurality of separate fire suppressant type supplies in communication with the at least one controller, and a plurality of dispensers, with at least one of the plurality of dispensers in communication with at least one of the plurality of separate fire suppressant type supplies, and wherein at least one of the plurality of dispensers configured to release the fire suppressant type delivered to the at least one of the plurality of dispensers in response to selected fire threat condition at the selected fire threat location.

In another aspect, a building is disclosed, with the building includes an apparatus for suppressing a detected fire threat in a contained environment within a structure, with the apparatus including a plurality of detectors, with the plurality of detectors comprising a plurality of detector types, and with each of the plurality of detector types configured to detect a fire threat condition in a fire threat location within the structure, the plurality of detector types further comprising differing detector types. The apparatus further includes a processor, with the processor in communication with at the plurality of detectors, at least one controller, with the controller configured to receive a signal from at least one of the processor and at least one of the plurality of detectors, a plurality of fire suppressant types, with the plurality of fire suppressant types differing from one another, with each of the plurality of fire suppressant types configured to be housed in a plurality of separate fire suppressant type supplies, with each of the plurality of separate fire suppressant type supplies in communication with the at least one controller, and a plurality of dispensers, with at least one of the plurality of dispensers in communication with at least one of the plurality of separate fire suppressant type supplies, and wherein at least one of the plurality of dispensers configured to release the fire suppressant type delivered to the at least one of the plurality of dispensers in response to selected fire threat condition at the selected fire threat location.

In another aspect, each of the detector types is configured to detect at least one of a first fire threat condition and a subsequent fire threat condition in at least one fire threat location located within the structure, with the plurality of detector types further comprising differing detector types, and wherein at least one of the plurality of dispensers is configured to release at least one of plurality of fire suppressant types delivered to the at least one of the plurality of dispensers in response to at least one of a detected first fire threat condition and a subsequent fire threat condition in the fire threat location.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

Having thus described variations of the disclosure in general terms, reference will now be made to the accompanying drawings, which are not necessarily drawn to scale, and wherein:

FIG. 1 is a schematic view of an apparatus and system, according to present aspects;

FIG. 2 is an illustration of an aircraft incorporating fire suppression apparatuses and systems, according to present aspects;

FIG. 3 is an illustration of a building incorporating fire suppression apparatuses and systems, according to present aspects;

FIG. 4 is a flowchart outlining methods according to present aspects;

FIG. 5 is a flowchart outlining methods according to present aspects;

FIG. 6 is a flowchart outlining methods according to present aspects; and

FIG. 7 is a flowchart outlining methods according to present aspects.

### DETAILED DESCRIPTION

Presently disclosed apparatuses, systems, and methods disclose a highly versatile fire suppression system for contained environments including contained environments within large structures, including, for example, buildings and vehicles, including, for example, aircraft. According to present aspects, fire suppressant systems include a variety of fire suppressant types that can be delivered to the site of a detected fire threat to best address a detected fire threat at a detected fire threat location.

According to present aspects, at least one fire threat condition can be detected at a fire threat location within a contained environment by one or more fire threat detectors (referred to equivalently herein as “detectors”). The detectors can include detectors that detect changes in heat within a selected location (e.g., heat detectors), detectors that detect flames and flames ignition in a selected location (e.g., flame detectors), detectors that can detect changes in particulate concentration (that can include smoke particles) in a selected location (e.g., smoke detectors).

A non-exclusive listing of smoke detectors that can be incorporated in the presently disclosed systems, apparatuses, and methods includes, for example, ionization-area type smoke detectors, photoelectric-area type smoke detectors, photoelectric-ducted type smoke detectors, etc., including, for example, Grainger 4WTA-B Photoelectric Smoke Detector with Thermal. A non-exhaustive listing of presently contemplated heat detectors for use in the present aspects includes, for example, heat detectors including: 200 Series Intelligent Heat Detectors (Honeywell); 5809 Wireless Fixed Heat Rate-of-Rise Detector (Honeywell); 4WTA-B Photoelectric Smoke Detector with Thermal (Grainger), etc. A non-exhaustive listing of presently contemplated flame detectors for use in the present aspects includes, for example, flame detectors, including: FSL 100 Flame Detectors (Honeywell); 20/20 Series Flame Detectors (Spectrex); 40/40 Series Flame Detectors (Spectrex); FL500 Ultraviolet/Infrared Flame Detectors (MSAQ); Drager Flame 1500(IR3) (Drager), etc.

Fire threats can progress in a threat stage progression within a contained environment. While present aspects can pertain mitigating and eliminating a detected fire threat from contained environment within a large structure, for example, an aircraft, etc., present aspects can also apply to and be configured to be installed, retro-fitted, etc. to mitigate and/or eliminate detected fire threats in buildings, (e.g., occupied buildings as well as, for example, warehouses, hangers, storage facilities, etc.

According to present aspects, a plurality of detector type, facilitates real time identification and detection of multiple types of fire threat conditions (referred to equivalently herein as a “multi-type fire threat”) occurring or about to occur at a particular location within a contained environment. According to further present aspects, once a fire threat condition has been identified and detected at an identified fire threat location, present systems and methods effect a selected release of a selected fire threat suppressant that best suits the identified and detected fire threat condition in response to the detected fire threat condition.

According to further present aspects, if multiple fire threat conditions are detected at a (single) fire threat location within a contained environment within a large structure, present systems and methods can deliver to a detected fire threat location a selected release of a one or more selected fire threat suppressants, concurrently or sequentially, that best suits the identified and detected multiple fire threat conditions in response to the detected multiple fire threat conditions. That is, one or more fire suppressant is selected, released from one or more selected fire suppressant supplies, and delivered to a detected fire threat location, concurrently or sequentially, in response to the multiple fire threat conditions detected at the fire threat location.

According to further present aspects, if multiple fire threat conditions are detected at one of more fire threat locations within contained environments of a large structure, present systems and methods can deliver, sequentially or concurrently, to the one or more than one (e.g., multiple) detected fire threat locations a selected release of a one or more selected fire threat suppressants that best suit the identified and detected multiple fire threat conditions in response to the detected multiple fire threat conditions. That is, a fire suppressant is selected, released from one or more selected fire suppressant supplies, and delivered to one or more detected fire threat locations, concurrently or sequentially, in response to the multiple fire threat conditions at the one or more fire threat locations.

According to present aspects, the presently disclosed systems and methods contemplate and comprise a tailored approach to fire response and fire mitigation within a contained environment of a large structure, also referred to herein as a “tiered” approach. According to the present systems and methods, since a particular type of fire threat condition is detected by fire detector types, the most efficacious and efficient fire suppressant type can be selected from a plurality of fire suppressant type supplies, with the plurality of fire suppressant types varying from one another, and with each of the plurality of fire suppressant types stored separately from one another in discrete, fire suppressant supplies, that can each be centralized fire suppressant supplies. The fire suppressant type that is selected is then released from the selected fire suppressant supply and delivered to the close vicinity of fire threat location detected by the present systems, and according to present methods, at least in response to the detected fire threat type.

According to further present aspects, and according to the tiered approach to the delivery of fire suppressants released in response to detected fire threats, presently disclosed systems can selectively deliver a fire suppressant type in the form of a gaseous agent fire suppressant in response to detected smoke for the purpose of decreasing oxygen in a detected fire threat location in a contained environment, and otherwise interrupt the “fire tetrahedron”.

A “fire tetrahedron” (also referred to as fire diamond, pyramid, or combustion triangle) refers to the four elements recognized as requisite entities for sustaining a combustion process, with the four elements representing oxygen (for sustaining combustion), heat for raising a temperature to a material's ignition temperature), fuel (a combustible material source), and subsequent exothermic chain reaction in the fuel material. All four elements of the tetrahedron must be present for the occurrence of fire—i.e. oxygen, heat, fuel, and a chemical chain reaction; with the removal of any one element resulting in the extinguishing of a fire. A fire can be extinguished by, for example, creating or providing a barrier to oxygen (e.g., a foam, gel or powder); providing water to lower a temperature below a fuel's ignition temperature; removing a combustible fuel; and/or interfering with a fire's chemical chain reaction (e.g., through the elimination of free radicals using, for example, a Halon extinguisher containing, for example HALON 1211, HALON 1301, etc.).

In a further aspect, presently disclosed systems can selectively deliver a fire suppressant type in the form of a solid (e.g., powder, foam, flocculant, etc.) fire suppressant agent in response to detected ignition (e.g., flame detection) for the purpose of inhibiting or mitigating or preventing the propagation of combustion detected fire threat location in a contained environment, and otherwise interrupt the “fire tetrahedron”.

In a further aspect, presently disclosed systems can selectively deliver a fire suppressant type in the form of a liquid (e.g., water, etc.) fire suppressant agent in response to detected heat (e.g., detected heat delta, etc.) for the purpose of inhibiting, mitigating or preventing the propagation of combustion occurring at a detected fire threat location in a contained environment via heat absorption (e.g. absorb heat/energy of a fire) to inhibit the spread of fire in a combustion process and otherwise interrupt the fire tetrahedron. While an oxygen deprivation fire suppressant agent such as a Halon-type agent can be effective for a fire that is observable, fire types that generate significant heat could benefit from present aspects, including where a fire suppressant type that can lower a fire fuel's temperature is either also needed to ameliorate a fire threat, or could work in concert with an oxygen depriving fire suppressant. In such instances, present aspects contemplate detecting more than one fire threat condition, otherwise referred to equivalently herein as a “multi-type fire threat” (e.g., smoke, heat, flame, etc., detected concurrently) and directing more than one fire suppressant type to a fire threat location where the plurality of fire threat conditions have been detected concurrently or sequentially.

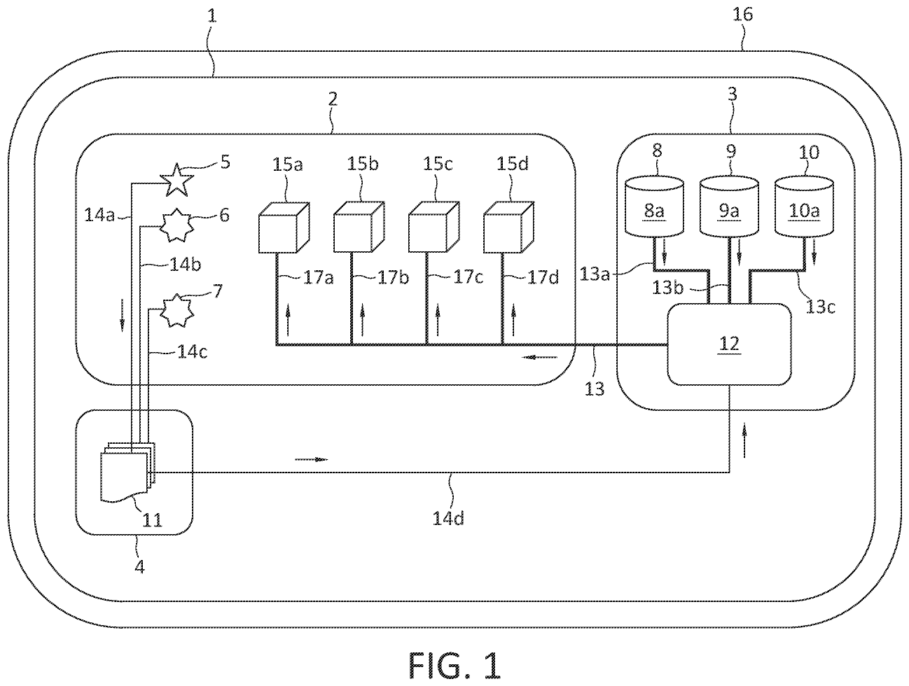

FIG. 1 is a box diagram representing aspects of the presently disclosed systems. As shown in FIG. 1, a structure 16 that can be a large structure, such as, for example, an aircraft, a vehicle, a building, etc., includes a system 1 for suppressing a detected fire threat that further includes a contained environment 2. When in a vehicle, the contained environment 2 can be, for example, a vehicle passenger cabin, a vehicle storage compartment, a vehicle equipment bay, a vehicle engine compartment, a vehicle power supply (e.g., battery, auxiliary power unit, or APU, etc.) compartment, a vehicle monument (e.g., lavatory, closet, etc.), a vehicle cargo hold, etc. When a structure 16 is, for example, a building, the contained environment 2 can be, for example, a room, an office, a closet, an equipment room, a storage room, a lavatory, etc.

FIG. 1 further shows an equipment plant 3 that can be configured to contain fire suppressant type supplies 8a, 9a, 10a that, in turn are configured to house, respectively, a gaseous fire suppressant type 8, a solid fire suppressant type 9, and a liquid fire suppressant type 10. While FIG. 1 illustrates a singular equipment plant 3 within one location containing three varying fire suppressant types in three separate fire suppressant type supply containers, present alternate aspects further contemplate locating the fire suppressant supplies of fire suppressant system 1 in separate locations within the larger structure 16. Regardless of whether the fire suppressant supplies are located within one general location, or each located at separate locations, present aspects contemplate a fire suppressant system that is considered to deliver a fire suppressant type, on demand, in real time, and in response to a detected fire threat condition at fire threat locations that can be located at significant distances from, and otherwise located remotely from the fire suppressant type supplies. According to present aspects, the fire suppressant type supplies are preferably centralized fire suppressant type supplies.

FIG. 1 further shows a plurality of detectors that represent a plurality of detector types. As shown in FIG. 1, detector 5 can be in the form of a smoke detector type, detector 6 can be in the form of a flame detector type (also referred to equivalently herein as an “ignition detector type”), and detector 7 can be in the form of a heat detector type. According to present aspects, smoke, flame, and heat represent three fire threat conditions that can each be detected by the respective detector types. According to present aspects, depending, for example, on the overall scale and size of the area of a large structure employing the present systems, apparatuses, and methods, a plurality of each detector type can be located throughout the contained environment 2 within structure 16, and further, a structure 16 can comprise a plurality of contained environments 2 that are located remotely from and discretely from one another. In such instances, according to present aspects, a plurality of detectors and a plurality of detector type can be located to monitor a plurality of contained environments.

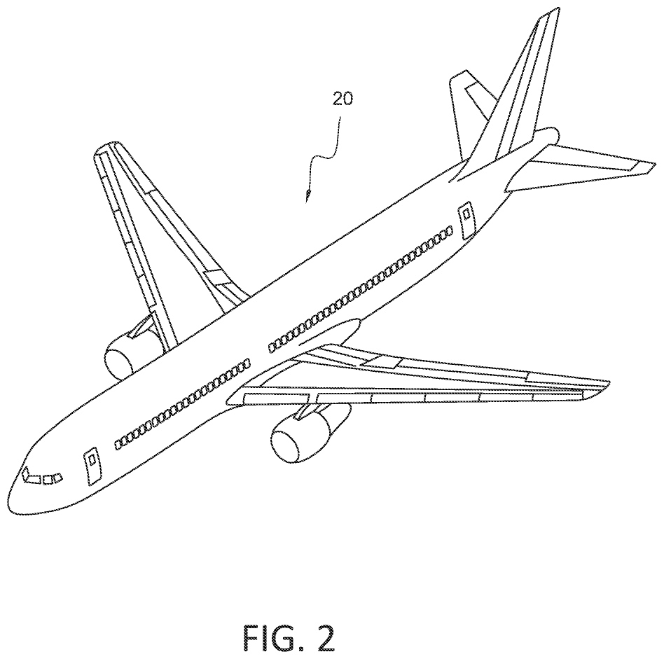

For example, when the structure 16 is a passenger aircraft 20, as shown in FIG. 2 present aspects contemplate the positioning of the aforementioned plurality of detectors and plurality of detector types positioned throughout a plurality of contained environments through the aircraft interior, with such contained environments at least including, for example, a passenger compartment, a cockpit, a crew rest area, storage bins, baggage compartments, a vehicle power supply compartment, monuments that can be contained and that can include lavatories, etc., as well as monuments that may not be completely contained including, for example, galleys, etc. According to further present aspects, components of the presently disclosed systems can be further located to detect fire threat conditions at fire threat locations and disperse selected fire suppressant types, on demand, and in real time, in response to detected fire threats occurring in additional aircraft locations that may not be inhabited by personnel and/or passengers, with such uninhabited aircraft locations including, for example, engine compartments, cargo holds, areas between the fuselage interior and an aircraft cabin ceiling, etc.

FIG. 1 further shows aspects according to present aspects where, in operation, detector 5, upon detecting a fire threat condition associated with the detector type (e.g., smoke, flame, heat, etc.) detector 5 is configured to send data (that can be in form of signals) regarding the detected fire threat condition from the detector 5 via data transfer line 14a to processor 4, with processor 4 comprising or otherwise in communication with software 11 to process the data/signal received from detector 5. As also shown in FIG. 1, detectors 6 and 7, upon detecting a fire threat condition associated with the detector type (e.g., smoke, flame, heat, etc.), detectors 6, 7 are configured to send data (that can be in form of signals) regarding the detected fire threat condition detected by detectors 6, 7, with the data sent from the detector 6, 7 via data transfer lines 14b, 14c, respectively, to processor 4, with processor 4 comprising or otherwise in communication with software 11 to process the data/signal received from one or both of detectors 6, 7.

Further present aspects show signals that can be converted as appropriate by processor 4 and that can move in the direction as indicated by the “arrow” to a controller 12 that can control suppressant distribution, and that is shown as located in equipment bay 3. Controller 12 then directs signals to actuators (not shown) that are configured to facilitate a selected release a flow of fire suppressant from an associated fire suppressant supply. In operation, as shown in FIG. 1, controller receives a notification/signal from a processor regarding the detection of a particular fire threat condition. The processor can interpret the information from the detector and send an associated signal to the controller, with the controller directing the release of a fire threat suppressant type from a fire suppressant type supply in response to the detected fire threat condition. A fire suppressant type flow is established upon the release of a fire suppressant type from a fire suppressant type supply, for example, as directed by the controller.

As shown in in FIG. 1, if a fire threat condition in the form of smoke is detected by detected by detector 5, that can be a smoke detector, the detected smoke is the fire threat condition detected by the smoke detector, and signals are sent to the processor that relays information to the controller, with the controller then effecting the release of a selected fire suppressant type to address the detected smoke as the fire condition threat. As shown in FIG. 1, a detected smoke fire threat condition can warrant a desired fire suppressant type flow release associated with a gaseous (e.g., Halon-type) fire suppressant type 8 from fire suppressant type supply 8a that is then directed via supply line 13a to plumbing line 13 that then directs the released fire suppressant type flow to an individual location within the structure and to the site of the detected fire threat location where the fire threat condition was detected.

As also shown in in FIG. 1, if a fire threat condition in the form of flame and/or heat is detected by detectors detector 6, 7, that can be a flame detector and a heat detector, respectively, the detected flame and/or heat are the fire threat conditions detected by the flame detector and a heat detector, respectively, and signals are sent to the processor that then can relay information to the controller, with the controller then configured to effect the release of a selected fire suppressant type to address the detected flame and/or heat fire condition threat type. As shown in FIG. 1, a detected flame and/or heat fire threat condition can warrant a desired fire suppressant type flow release associated with a solid and/or liquid fire suppressant type 9, 10, respectively from fire suppressant type supplies 9a, 10a respectively, and that are then directed via supply lines 13b, 13c, respectively, to plumbing line 13 that then direct the released fire suppressant type flow to an individual location within the structure and to the site of the detected fire threat location (e.g., the site where the fire threat condition was detected.).

As further shown in FIG. 1, the selected fire suppressant type determined by the system and in response to the detected fire threat condition (as detected by one or more detectors and detector types, for example) is directed from the fire suppressant type supplies, as fire suppressant type flows along individual dispenser lines 17a, 17b, 17c, 17d, into associated dispensers 15a, 15b, 15c, 15d. While FIG. 1 shows four dispenser lines leading into respective and associated four dispensers, present aspects contemplate any useful number of individual dispensers that may each comprise individual dispenser lines (as shown in FIG. 1), and/or any number of dispensers may share dispenser lines (not shown in FIG. 1) as desired according to system architecture choices.

According to present aspects, certain fire suppressant types can be present within large structures for various non-fire-related purposes, especially liquid fire suppressants such as, for example, water. With respect to at least water, amounts of water from a centralized potable or non-potable water supply on board an aircraft (that has other uses on board the aircraft for the water) can be in communication with the present systems and re-purposed as volumes of available liquid fire suppressant of the type used to decrease the ignition temperature of a fire's fuel, for example.

When the large structure incorporating presently disclosed systems is a building into and through which a water flow is directed for washing, drinking, and sanitation purposes, such water volumes can be re-purposed into the presently disclosed fire suppression systems. Indeed, in the case where a building is connected to a municipal water supply, such a building would have a virtually limitless “centralized” water supply.

According to further present aspects, the disclosed systems can direct a fire suppressant type on demand, and in real time, and in a tailored response to a detected fire threat condition from a centralized fire suppressant type supply and can obviate the need to station various fire suppressant devices having a limited volume of suppressant (e.g., handheld devices, fire extinguishers, etc.) at various random locations throughout contained environments within a large structure. The improved targeted release of optimal fire suppressants (that are selected for release based on, and in response to, a detected fire threat condition at a detected location, according to present aspects) conserves fire suppressant supply, as the specific need to ameliorate a detected fire threat condition drives the decision as to whether to release a suppressant based on the desired and selected primary purpose of the fire suppressant type in “breaking” or interrupting a combustion process of a fire or fire threat (e.g., oxygen starvation/reduction, temperature reduction, chemical reaction interruption, etc.).

According to present aspects, fire suppressant supply volumes can vary and find limits only in terms of selected design and structure architecture. The presently disclosed fire suppressant supplies realize a significant improvement in the total volume of suppressant available to be directed to address a fire threat within a contained environment of a large structure. That is, in the case of an aircraft, for example, the supply of gaseous, liquid, and solid fire suppressant contained and available within a centralized fire suppressant supply, or “tank” can have a significantly large average volume capacity; far in excess of the fire suppression hand-held extinguishers placed at several locations throughout a cabin for use by personnel. For example, a centralized tank of, for example, gaseous Halon 1301 for delivery to an aircraft cargo compartment can have an average storage capacity of about 270 lbs. of Halon 1301 on board an aircraft within a centralized storage tank. By way of further example, a centralized storage tank of Halon 1301 configured to deliver the gaseous fire suppressant Halon 1301 to, for example, an engine or auxiliary power unit (APU) can have a capacity of about 70 lbs. of Halon 1301.

Such a volume of fire suppressant supply deliverable to a fire threat location from a centralized supply, according to present aspects, represents an order of magnitude improvement in terms of overall safety and efficient response to a fire event as compared to the volumes of fire suppressant typically contained, even when full, in an average hand-held fire extinguisher configured to be manually operated by personnel.

Still further, according to present aspects, in the event of a fire occurring within a contained environment of a large structure (e.g., vehicle in motion, aircraft in flight, and even a stationary building, etc.), the automated detection of a fire threat condition, selection of a suppressant in response to the detected fire threat condition, and directed release of the selected fire suppressant in response to a detected fire threat type can be effected faster, more efficiently, with a targeted, tailored, and automated response to the particular detected fire threat condition type, without the direct involvement of human personnel acting as firefighters, and therefore the present systems, apparatuses, and methods afford significant improvements in terms of worker/personnel/flight attendant personal safety.

According to present aspects, the term “real-time” as used herein denotes a very short time by which the system responds to a detected fire threat condition. In most instance, the present systems will detect a fire threat condition, select the most appropriate fire suppressant based on, and in response to, the detected fire threat condition, and dispense the selected fire suppressant from a fire suppressant supply in response to the detected fire threat condition within a time ranging from about 1 to about 5 seconds, and more preferably within a time ranging from about 0.5 seconds to about 2 seconds.

The system as shown in FIG. 1 can further comprise pumps, valving, shutoffs, sensors (e.g., confirmatory flow sensors, etc.) installed as appropriate according to design choices and system architecture choices, with the understanding that, according to present aspects, a pressurized system can be established with one or more pumps located in line within the presently disclosed systems to direct a selected fire suppressant type flow at a desired flow rate and at a desired pressure within controlling regulations for such systems. The systems, according to present aspects, and as illustrated herein, are representative only and are not limiting through the absence of illustrated mechanical or electrical hardware, or other elements incorporated to establish, maintain, and terminate a selected fire suppressant type flow in response to, on demand and in real time, one or more detected fire threat conditions at one or more detected fire threat locations.

FIG. 2 is a vehicle in the form of an aircraft, and representative of a type of large structure into which the present fire suppression systems can be fitted and/or retrofitted. According to further aspects, a vehicle into which the present fire suppression systems can be fitted and/or retrofitted can be selected from the group consisting of a crewed aircraft, an uncrewed aircraft, a crewed spacecraft, an uncrewed spacecraft, a crewed rotorcraft, an uncrewed rotorcraft, a crewed terrestrial vehicle, an uncrewed terrestrial vehicle, a crewed surface water borne vehicle, an uncrewed waterborne vehicle, a crewed sub-surface water borne vehicle, an uncrewed sub-surface water borne vehicle, a satellite, and combinations thereof.

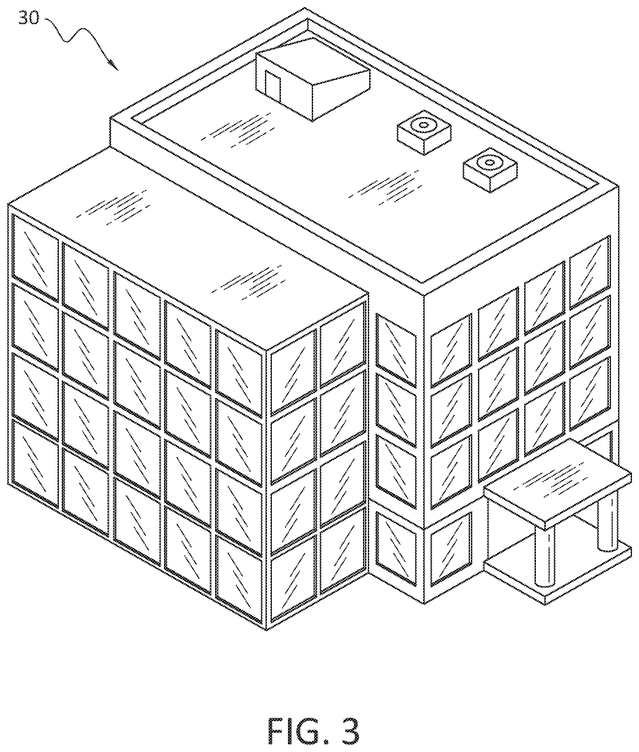

FIG. 3 is a building representative of a type of large structure into which the present fire suppression systems can be fitted and/or retrofitted.

The following Examples are non-exhaustive descriptions of the possibilities of the presently disclosed apparatuses, systems, and methods, and are instead presented for illustration purposes representing operational scenarios implementing the apparatuses, systems, and methods disclosed herein.

### Example 1A

One Fire Threat Condition—One Fire Threat Location.

According to a first Example 1A, a presently disclosed fire suppression system as shown in FIG. 1 is incorporated into a passenger aircraft. Example 1A addresses the use of present systems to identify and detect a single fire threat condition at a single fire threat location. A selected number of detectors 5, 6, and 7 are positioned within inhabited and uninhabited regions of the aircraft. Inhabited regions as disclosed herein refer to passenger cabins, as well as the storage compartments and monuments that further reside within a passenger cabin and that would be near and proximate to human passengers. In addition, a selected number of dispensers 15a, 15b, 15c, 15d, that also can include a greater number of dispensers than the four dispensers shown, are installed at regular intervals throughout inhabited regions in a passenger cabin with dispensers further installed in compartments, bins, monuments, monument areas near passengers. In the event a fire threat condition occurs, detectors, 5, 6, 7 detect a fire threat condition. According to Example 1A, if a smoke detector detects smoke (a detected fire threat condition) the smoke detector, dedicated to and identified by the system as occupying a particular location, relays information to a processor 4 that relays the detection signal generated by the detector to the controller 12 that then directs a release of gaseous fire suppressant 8 from gaseous fire suppressant supply (tank) 8a. The released gaseous fire suppressant flow then travels and is routed from the supply tank through the supply line 13a and further routed (e.g., in an automated regimen) to dispenser lines in communication with the dispenser located nearest to the detected fire threat location. If desired, and according to further present aspects, a gaseous fire suppressant flow may also be directed to dispensers at locations near and surrounding the fire threat location to form, for example, a fire suppression perimeter. By restricting the release of a particular fire suppressant type (e.g., gaseous fire suppressant to deprive as smoldering fire threat from oxygen required to continue a combustion process)) in response to the detected fire threat condition (e.g., smoke)) to dispensers located or otherwise positioned adjacent and surrounding the fire threat location, the total amount of fire suppressant released can be reduced, and the fire threat is best addressed through the initial assessment of fire threat type via the information relayed to the system by, for example, the smoke detector.

Example 1A further contemplates a fire threat condition detected by a flame detector, with the fire suppressant type selected by the system accordingly so that a solid fire suppressant can be delivered to inhibit further oxygen and extinguish a flame. When a flame/ignition detector relays a fire threat condition signal based on the presence of a detected flame/ignition in a region monitored and detected by such flame/ignition detector, the flame/ignition detector sends a signal to the processor that then sends the signal to the controller and such signal triggers the release of a selected solid fire suppressant type (e.g., powder, foam, etc.) that is directed via suppressant supply and dispenser lines such that the selected fire suppressant type is directed to the identified and detected fire threat location to “douse” an emerging fire's fuel and deprive the emerging fire of oxygen and/or interrupt the chemical/combustion chain reaction of the fire.

Further, if a heat detector relays a fire threat condition signal based on a detected heat change in a region monitored and detected by such heat detector, the heat detector sends a signal to the processor that then sends the signal to the controller and such signal triggers the release of a selected liquid fire suppressant type (e.g., water) that is directed via suppressant supply and dispenser lines such that the selected fire suppressant type is directed to the identified and detected fire threat location to “douse” an emerging fire's fuel and lower the temperature of the fuel below an ignition temperature.

Example 1A can further apply to a scenario where one fire threat condition is identified by a detector and reported to the system as originating at an uninhabited aircraft region (e.g., engine compartment, cargo bay, equipment bay, auxiliary power unit, vehicle battery bank, etc.). In the event such a fire event is detected in an uninhabited aircraft region, present aspects contemplate detectors and dispensers positioned in such uninhabited regions, such that the fire suppressant type is selected on demand, in real time, and in response to the fire threat condition, with the fire suppressant type delivered vie delivery lines and dispenser lines to the fire threat location in the uninhabited aircraft region.

### Example 1B

One Fire Threat Condition Type—Multiple Fire Threat Locations

In the Example 1B, according to further aspects of the presently disclosed apparatuses, systems, and methods, the system shown in FIG. 1 is incorporated in a passenger aircraft and is configured to detect one (a single) fire threat condition type identified and detected by detectors at multiple fire threat locations. A selected number of detectors 5, 6, and 7 are positioned within inhabited and uninhabited regions of the aircraft. An inhabited region herein refers to passenger cabins, as well as the storage compartments and monuments that further reside within a passenger cabin and that would be near human passengers. In addition, a selected number of dispensers 15a, 15b, 15c, 15d, that can include a greater number than the four dispensers shown, are installed at regular intervals throughout inhabited regions in a passenger cabin with dispensers further installed in compartments, bins, monuments, monument areas near passengers. In the event a fire threat condition occurs, one of detector type, 5, 6, 7 detects a fire threat condition. According to Example 1B, if a smoke detector detects smoke (a fire threat condition type) smoke detectors are dedicated to and identified by the system as occupying a plurality of locations. The smoke detectors 5 are configured to relay information to a processor 4 that relays the detection signal generated by the detector 5 to the controller 12 that then directs a release of gaseous fire suppressant 8 from gaseous fire suppressant supply (tank) 8a. The released gaseous fire suppressant flow then travels through the supply line 13a to dispenser lines in communication with the dispenser located nearest to the plurality of detected fire threat location.

If desired, and according to further present aspects, a gaseous fire suppressant flow may also be directed to dispensers at locations near and surrounding the plurality of detected fire threat locations to form a fire suppression perimeter. By restricting the release of a particular fire suppressant type (e.g., gaseous fire suppressant to deprive as smoldering fire threat from oxygen required to continue a combustion process)) in response to the detected fire threat condition (e.g., smoke)) to dispensers located or otherwise positioned adjacent and surrounding the plurality of fire threat location, the total amount of fire suppressant released can be reduced as compared to typical fire suppression systems, and, according to present aspects, the fire threat is best addressed through the initial assessment of fire threat type via the information relayed to the system by the smoke detector.

Example 1B further contemplates a fire threat condition detected by a flame detector, with the fire suppressant type selected by the system accordingly so that a solid fire suppressant can be delivered to inhibit further oxygen and extinguish a flame. When a flame/ignition detector relays a fire threat condition signal based on the presence of a detected flame/ignition in a region monitored and detected by such flame/ignition detector, the flame/ignition detector sends a signal to the processor that then sends the signal to the controller and such signal triggers the release of a selected solid fire suppressant type (e.g., powder, foam, etc.) that is directed via suppressant supply and dispenser lines such that the selected fire suppressant type is directed to the plurality of identified and detected fire threat locations to “douse” an emerging fire's fuel and deprive the emerging fire of oxygen and/or interrupt the chemical/combustion chain reaction of the fire.

Further, if a heat detector relays a fire threat condition signal based on a detected heat change in a plurality of regions monitored and detected by such heat detector, the heat detector sends a signal to the processor that then sends the signal to the controller and such signal triggers the release of a selected liquid fire suppressant type (e.g., water) that is directed via suppressant supply and dispenser lines such that the selected fire suppressant type is directed to the plurality of identified and detected fire threat locations to “douse” an emerging fire's fuel and lower the temperature of the fuel below an ignition temperature.

Example 1B can further apply to a scenario where one fire threat condition type occurs at a plurality of fire threat locations and the fire threat condition type occurring at a plurality of fire threat locations are identified by a detector and reported to the system as originating at, for example, an uninhabited aircraft region (e.g., engine compartment, cargo bay, equipment bay, auxiliary power unit, vehicle battery bank, etc.), or at both inhabited and uninhabited regions/locations within an aircraft. In the event such a fire event is detected in a plurality of fire threat locations that can include an uninhabited aircraft region, present aspects contemplate detectors and dispensers positioned in such uninhabited regions, such that the fire suppressant type is selected on demand, in real time, and in response to the fire threat condition detected at a plurality of fire threat locations, with the fire suppressant type delivered via delivery lines and dispenser lines to the plurality of the detected fire threat locations in the uninhabited aircraft regions and or inhabited aircraft regions.

### Example 2A

Multiple Detected Fire Threat Condition Types—One Fire Threat Location

According to Example 2A, the present apparatuses, systems, and methods can detect multiple and differing fire threat condition types that can occur at a single location. According to further aspects of the presently disclosed apparatuses, systems, and methods, the system shown in FIG. 1 is incorporated in a passenger aircraft and is configured to detect a plurality of fire threat condition types identified and detected by multiple detector types at a single fire threat location. A selected number of detectors from among the multiple detector types (e.g., smoke, flame/ignition, heat) presented in FIG. 1 as detectors 5, 6, and 7 are positioned within and throughout inhabited and uninhabited regions of the aircraft at selected intervals. As explained herein, a selected number of dispensers 15a, 15b, 15c, 15d, and that can include a greater number than the four dispensers shown, are installed at regular intervals throughout inhabited regions in a passenger cabin with dispensers further installed in compartments, bins, monuments, monument areas near passengers.

In the event multiple (e.g., a plurality of) fire threat condition types occur at a single location, smoke, flame, and heat detectors can together detect a plurality of fire threat conditions also referred to equivalently herein as fire threat condition types) occurring, or about to occur, at a single location. According to Example 2A, multiple detector types located within a vicinity of a single fire threat location can, taken together, detect a plurality of fire threat conditions (smoke, flame, heat) occurring at a single fire threat location. Each detector type of the plurality of detector type are configured to relay information to a processor 4 that relays the detection signal generated by each detector type (a plurality of detector types shown as detectors 5, 6, 7 in FIG. 1) to the controller 12 that then directs a release of a plurality of fire suppressant types (8, 9, 10 in the form of fire suppressant type flows) from the respective fire suppressant supplies (8a, 9a, 10a) on demand and in real time to the fire threat location in response to the detected plurality of fire threat conditions.

Example 2A can further apply to a scenario where one or more fire threat conditions at a single fire threat locations are identified by a detector and reported to the system as originating at an uninhabited aircraft region (e.g., engine compartment, cargo bay, equipment bay, auxiliary power unit, vehicle battery bank, etc.), or at both inhabited and uninhabited regions/locations within an aircraft. In the event such a plurality of fire conditions is detected in a fire threat locations that can include an uninhabited aircraft region, present aspects contemplate detectors and dispensers positioned in such uninhabited regions, such that a plurality of fire suppressant types is selected on demand, in real time, and in response to the fire threat conditions detected at fire threat locations, with the fire suppressant types delivered via delivery lines and dispenser lines to the plurality of the detected fire threat locations in the uninhabited aircraft regions and or inhabited aircraft regions.

### Example 2B

Multiple Detected Fire Threat Conditions—Multiple Fire Threat Locations

According to Example 2B, the present apparatuses, systems, and methods can detect multiple and differing fire threat condition types that can occur at a plurality (e.g., multiple) detected fire threat locations. According to further aspects of the presently disclosed apparatuses, systems, and methods, the system shown in FIG. 1 is incorporated in a passenger aircraft and is configured to detect a plurality of fire threat condition types identified and detected by multiple detector types at a plurality of fire threat locations. A selected number of detectors from among the multiple detector types (e.g., smoke, flame/ignition, heat) presented in FIG. 1 as detectors 5, 6, and 7 are positioned within and throughout inhabited and uninhabited regions of the aircraft at selected intervals. As explained herein, a selected number of dispensers 15a, 15b, 15c, 15d, and that can include a greater number than the four dispensers shown, are installed at regular intervals throughout inhabited regions in a passenger cabin with dispensers further installed in compartments, bins, monuments, monument areas near passengers.

In the event multiple (e.g., a plurality of) fire threat conditions occur at a plurality of fire threat locations (e.g., simultaneously), a plurality of smoke, flame, and heat detectors can together detect a plurality of fire threat conditions occurring, or about to occur at a plurality of fire threat locations. According to Example 2B, multiple detector types located within a vicinity of a plurality of fire threat locations can, taken together, detect a plurality of fire threat conditions (smoke, flame, heat) occurring at a plurality of fire threat locations simultaneously. Each detector type of the plurality of detector types are configured to relay information to a processor 4 that relays the detection signal generated by each detector type (a plurality of detector types shown as detectors 5, 6, 7 in FIG. 1) to the controller 12 that then directs a release of a plurality of fire suppressant types (8, 9, 10 in the form of fire suppressant type flows) from the respective fire suppressant supplies (8a, 9a, 10a) on demand and in real time to the plurality of fire threat locations in response to the detected plurality of fire threat conditions.

The present systems can incorporate multiple plumbing lines, including, for example, a plurality of supply lines leading to and otherwise in communication with a plurality of dispenser lines to dispensers located at a singular fire threat location or single fire threat location region the is proximate to and/or otherwise surrounds a single fire threat location as well as a plurality of fire threat locations. Such plumbing, including lines, release and delivery controls, valving, pressurization capacity, monitoring, etc. is incorporated to modify the present systems to facilitate both of the concurrent release and/or the sequential release and delivery of the selected plurality of fire suppressant types from their respective supplies to the respective fire suppressant type dispensers on demand and in real time, in response to the plurality of fire threat condition types detected by a plurality of detector types. In further aspects, dispensers can be configured to direct more than one type of fire suppressant type flow concurrently or sequentially.

Example 2B can further apply to a scenario where one fire threat condition at a plurality of fire threat locations is identified by a detector and reported to the system as originating at an uninhabited aircraft region (e.g., engine compartment, cargo bay, equipment bay, auxiliary power unit, vehicle battery bank, etc.), or at both inhabited and uninhabited regions/locations within an aircraft. In the event such a fire event is detected in a plurality of fire threat locations that can include one or more uninhabited aircraft regions, present aspects contemplate detectors and dispensers positioned in such uninhabited regions, such that the fire suppressant type is selected on demand, in real time, and in response to the plurality of fire threat conditions detected at a plurality of fire threat locations, with the plurality of fire suppressant types delivered via delivery lines and dispenser lines to the plurality of the detected fire threat locations in the uninhabited aircraft regions and or inhabited aircraft regions.

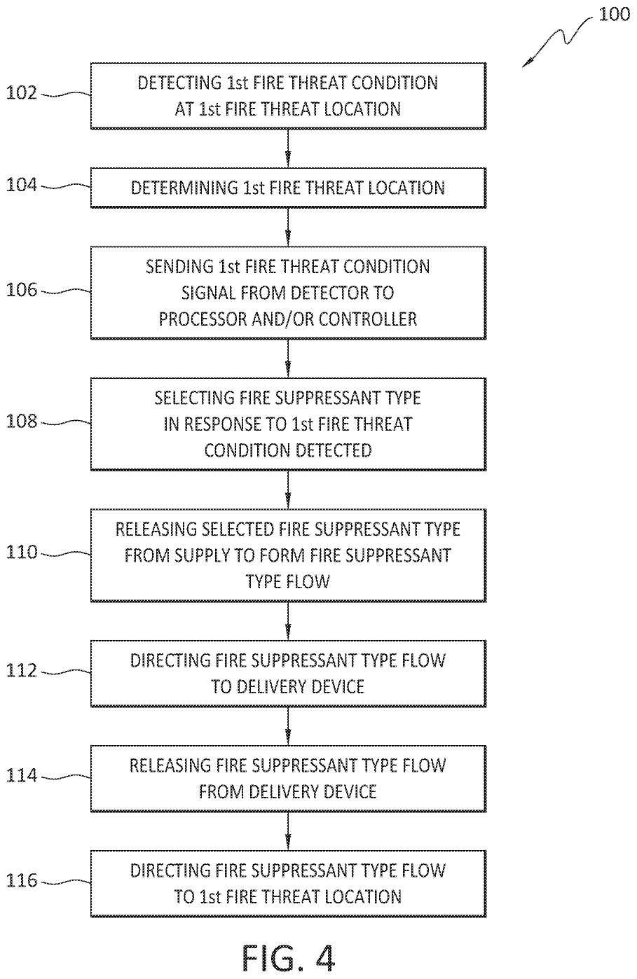

FIG. 4 is a flowchart outlining a method 100 for detecting and responding to a detected fire threat in a contained environment within a large structure, according to present aspects, with the method comprising detecting 102 a first fire threat condition at a first fire threat location within a structure, with the structure comprising at least one contained environment, with the first fire threat condition detected by at least one fire threat detector type, with the at least one fire threat detector type configured to send a first fire threat signal to a system processor, with the system processor in communication with at least one controller, with the at least one controller in communication with a plurality of fire suppressant types, with each of the plurality of fire suppressant types housed within a corresponding and separate fire suppressant type supply, and with each of the corresponding fire suppressant type supply positioned at a corresponding fire suppressant type supply location within the structure. The method 100 further includes determining 104 the first fire threat location within the structure, with the structure comprising at least one contained environment, sending 106 a first fire threat condition signal from the detector to at least one of the system processor and the system controller, selecting 108 at least one of the plurality of fire suppressant types from the corresponding and separate fire suppressant type supply to form a selected fire suppressant type in response to the first fire threat condition detected by the at least one fire threat detector type, and releasing 110 a selected amount of the at least one of the plurality of selected fire suppressant types from the selected fire suppressant type supply to form a selected fire suppressant type flow in response to the first fire threat condition signal. The method further includes directing 112 the selected fire suppressant type flow to at least one fire suppressant delivery device, releasing 114 the selected fire suppressant type flow from the at least one fire suppressant delivery device, and directing 116 the selected fire suppressant type flow to the first fire threat location, storing each of the plurality of fire suppressant types within a corresponding separate and centralized fire suppressant type supply. According to present aspects, the presently disclosed systems and apparatuses disclosed herein an illustrated in FIG. 1 can be incorporated in conducting the method 100, outlined in FIG. 4 for at least the purpose of the purpose of detecting and responding to a detected fire threat condition in a contained environment within a large structure such as vehicles including aircraft at least of the type shown in FIG. 2 and also including buildings at least of the type shown, for example, in FIG. 3.

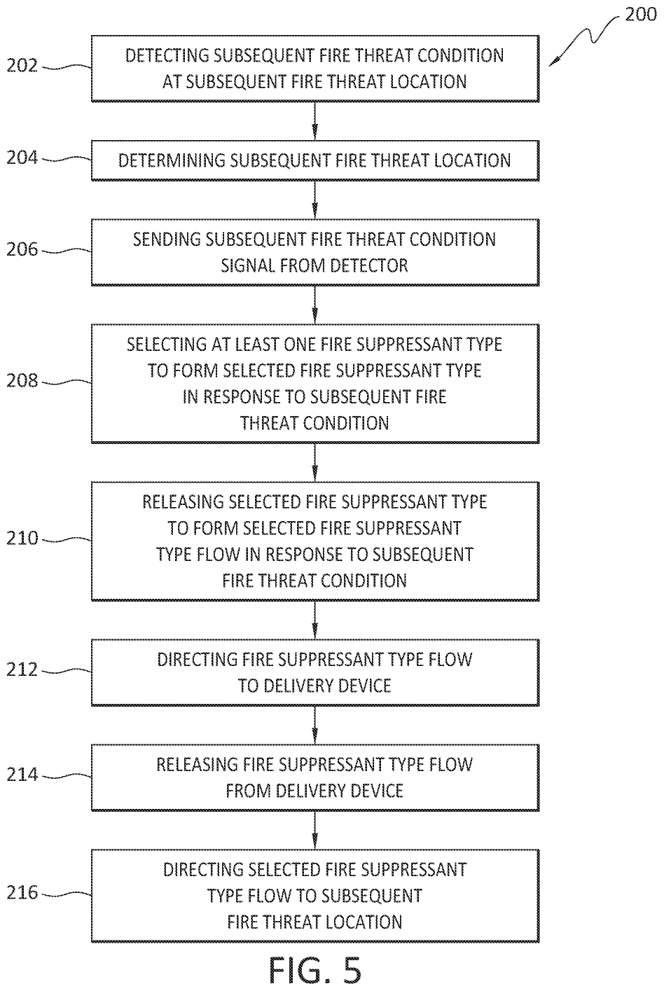

FIG. 5 outlines a further method according to present aspects, with a method 200 comprising detecting 202 a subsequent fire threat condition at a subsequent fire threat location within the structure, with the subsequent fire threat condition detected by the at least one fire threat detector type, with the at least one fire threat detector type configured to send a subsequent fire threat signal to the at least one of the system processor and the controller, with the system processor in communication with at least one controller, with the at least one controller in communication with at least two of the plurality of fire suppressant types, each of the at least two fire suppressant types housed within an associated fire suppressant type supply, determining 204 the subsequent fire threat location within the structure, with the structure comprising at least one contained environment, sending 206 a subsequent fire threat condition signal from the detector to at least one of the system processor and the system controller, selecting 208 at least one of the plurality of fire suppressant types to form a selected fire suppressant type, with the selection of the fire suppressant type conducted in response to the subsequent fire threat condition detected by the at least one fire threat detector type. Method 200 further comprises releasing 210 a selected amount of the selected fire suppressant type from the selected fire suppressant type supply to form a selected fire suppressant type flow in response to the subsequent fire threat signal, directing 212 the selected fire suppressant type flow to at least one fire suppressant delivery device, releasing 214 the selected fire suppressant type flow from the at least one fire suppressant delivery device, and 216 directing the selected fire suppressant type flow to the subsequent fire threat location. According to present aspects, the presently disclosed systems and apparatuses disclosed herein an illustrated in FIG. 1 can be incorporated in conducting the method 200, outlined in FIG. 5 for at least the purpose of the purpose of detecting and responding to a detected fire threat condition in a contained environment within a large structure such as vehicles including aircraft at least of the type shown in FIG. 2 and also including buildings at least of the type shown, for example, in FIG. 3.

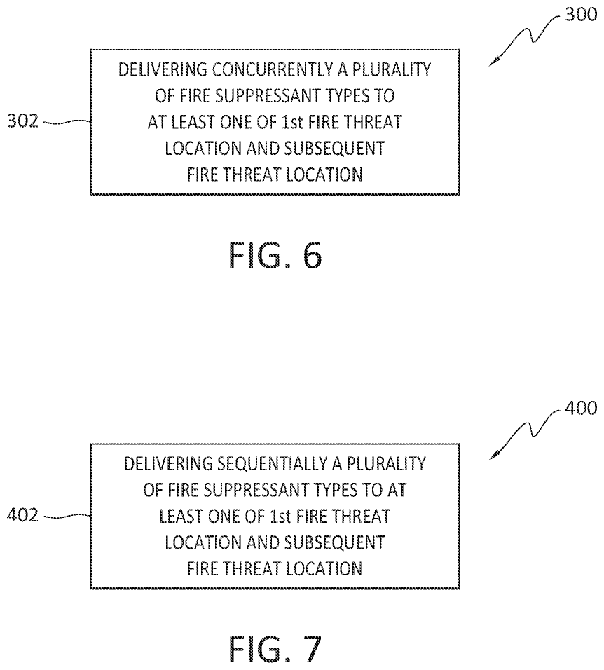

In another aspect, as shown in FIG. 6, a method 300 is outlined comprising the steps of methods 100 or 200, with method 300 further including delivering concurrently 302 a plurality of fire suppressant types to at least one of a first fire threat location and a subsequent fire threat location, with the plurality of fire suppressant types each comprising a different fire suppressant type in response to at least one of the first fire threat signal and the subsequent fire threat signal. According to present aspects, the presently disclosed systems and apparatuses disclosed herein an illustrated in FIG. 1 can be incorporated in conducting the method 300, outlined in FIG. 6, for at least the purpose of the purpose of detecting and responding to a detected fire threat condition in a contained environment within a large structure including vehicles such as aircraft at least of the type shown in FIG. 2 and also including buildings at least of the type shown, for example, in FIG. 3.

In another aspect, as shown in FIG. 7, a method 400 is outlined comprising methods 100 or 200, with method 400 further including delivering sequentially 402 a plurality of fire suppressant types to at least one of a first fire threat location and a subsequent fire threat location, with the plurality of fire suppressant types each comprising a different fire suppressant type in response to at least one of the first fire threat signal and the subsequent fire threat signal. According to present aspects, the presently disclosed systems and apparatuses disclosed herein an illustrated in FIG. 1 can be incorporated in conducting the method 400, outlined in FIG. 7 and for at least the purpose of the purpose of detecting and responding to a detected fire threat condition in a contained environment within a large structure such as vehicles including aircraft at least of the type shown in FIG. 2 and also including buildings, at least of the type shown, for example, in FIG. 3.

Methods 100, 200, 300 and 400 shown in FIGS. 4, 5, 6, and 7, respectively, can incorporate the plurality of fire suppressant types disclosed herein, including at least one of a solid fire suppressant, at least one of a liquid fire suppressant, at least one of gaseous fire suppressant, and combinations thereof.

The present aspects may, of course, be carried out in other ways than those specifically set forth herein without departing from essential characteristics of the disclosure. The present aspects are to be considered in all respects as illustrative and not restrictive, and all changes coming within the meaning and equivalency range of the appended claims are intended to be embraced therein.

What is claimed is:

1. A system for suppressing a detected fire threat in a contained environment within a structure, the system comprising:
a plurality of detectors, said plurality of detectors comprising a plurality of detector types, each of said plurality of detector types configured to detect a fire threat condition in a fire threat location within the structure, said plurality of detector types further comprising differing detector types;
a processor, said processor in communication with at the plurality of detectors;
at least one controller, said controller configured to receive a signal from at least one of the processor and at least one of the plurality of detectors;
a plurality of fire suppressant types, said plurality of fire suppressant types differing from one another, each of said plurality of fire suppressant types configured to be housed in a plurality of separate fire suppressant type supplies, each of said plurality of separate fire suppressant type supplies in communication with the at least one controller;
a plurality of dispensers, at least one of said plurality of dispensers in communication with at least one of said plurality of separate fire suppressant type supplies; and
wherein at least one of said plurality of dispensers is configured to release the fire suppressant type delivered to the at least one of the plurality of dispensers in response to selected fire threat condition at the selected fire threat location.

2. The system of claim 1, wherein at least one of said plurality of dispensers is in communication with more than one of the plurality of fire suppressant type supplies.

3. The system of claim 1, wherein the differing detector types are selected from the group consisting of: a heat detector; a smoke detector; a flame detector, a temperature change detector, and combinations thereof.

4. The system of claim 1, wherein the contained environment comprises at least one of: a passenger compartment, a monument, a storage compartment, a crew compartment, an engine compartment, a battery compartment, and a cockpit.

5. The system of claim 1, wherein at least one of the plurality of separate fire suppressant type supplies is located remotely from the fire threat location.

6. The system of claim 1, wherein the fire threat location is located within a contained environment within the structure.

7. The system of claim 1, wherein a detected fire threat comprises a detected multi-type fire threat.

8. A vehicle comprising the system of claim 1, said vehicle selected from the group consisting of:
a crewed aircraft, an uncrewed aircraft, a crewed spacecraft, an uncrewed spacecraft, a crewed rotorcraft, an uncrewed rotorcraft, a crewed terrestrial vehicle, an uncrewed terrestrial vehicle, a crewed surface water borne vehicle, an uncrewed waterborne vehicle, a crewed sub-surface water borne vehicle, an uncrewed sub-surface water borne vehicle, a satellite, and combinations thereof.

9. A building comprising the system of claim 1.

10. The system of claim 1, wherein each of said detector types is configured to detect at least one of a first fire threat condition and a subsequent fire threat condition in at least one fire threat location located within the structure, said plurality of detector types further comprising differing detector types; and
wherein at least one of said plurality of dispensers is configured to release at least one of plurality of fire suppressant types delivered to the at least one of the plurality of dispensers in response to at least one of a detected first fire threat condition and a subsequent fire threat condition in the fire threat location.

11. A vehicle comprising the system of claim 10, said vehicle selected from the group consisting of:
a crewed aircraft, an uncrewed aircraft, a crewed spacecraft, an uncrewed spacecraft, a crewed rotorcraft, an uncrewed rotorcraft, a crewed terrestrial vehicle, an uncrewed terrestrial vehicle, a crewed surface water borne vehicle, an uncrewed waterborne vehicle, a crewed sub-surface water borne vehicle, an uncrewed sub-surface water borne vehicle, a satellite, and combinations thereof.

12. A building comprising the system of claim 10.

13. A method for responding to a detected fire threat in a contained environment comprising:
detecting a first fire threat condition at a first fire threat location within a structure, said structure comprising at least one contained environment, said first fire threat condition detected by at least one fire threat detector type, said at least one fire threat detector type configured to send a first fire threat signal to a system processor, said system processor in communication with at least one controller, said at least one controller in communication with a plurality of fire suppressant types, each of said plurality of fire suppressant types housed within a corresponding and separate fire suppressant type supply, each of said corresponding and separate fire suppressant type supply positioned at a corresponding fire suppressant type supply within the structure;
determining a first fire threat location within the structure, said structure comprising at least one contained environment;
sending a first fire threat condition signal from the detector to at least one of the system processor and the at least one controller;
selecting at least one of the plurality of fire suppressant types from the corresponding and separate fire suppressant type supply to form a selected fire suppressant type in response to the first fire threat condition detected by the at least one fire threat detector type;
releasing a selected amount of the at least one of the plurality of selected fire suppressant types from a selected fire suppressant type supply to form a selected fire suppressant type flow in response to the first fire threat condition signal;
directing the selected fire suppressant type flow to at least one fire suppressant delivery device, said fire suppressant delivery device located proximate to the first fire threat location;
releasing the selected fire suppressant type flow from the at least one fire suppressant delivery device, said fire suppressant delivery device located proximate to the first fire threat location;
directing the selected fire suppressant type flow to the first fire threat location; and
wherein each of the plurality of fire suppressant types are stored within a corresponding separate and centralized fire suppressant type supply.

14. The method of claim 13, further comprising:
delivering concurrently a plurality of fire suppressant types to a first fire threat location, said plurality of fire suppressant types each comprising a different fire suppressant type in response to the first fire threat signal.

15. The method of claim 13, further comprising:
delivering sequentially a plurality of fire suppressant types to a first fire threat location, said plurality of fire suppressant types each comprising a different fire suppressant type in response to the first fire threat signal.

16. The method of claim 13, wherein the plurality of fire suppressant types comprise at least one of a solid fire suppressant, at least one of a liquid fire suppressant, at least one of gaseous fire suppressant, and combinations thereof.

17. The method of claim 13, wherein the structure is selected from the group consisting of: a vehicle and a building.

18. The method of claim 17, wherein the vehicle is selected from the group consisting of:
a crewed aircraft, an uncrewed aircraft, a crewed spacecraft, an uncrewed spacecraft, a crewed rotorcraft, an uncrewed rotorcraft, a crewed terrestrial vehicle, an uncrewed terrestrial vehicle, a crewed surface water borne vehicle, an uncrewed waterborne vehicle, a crewed sub-surface water borne vehicle, an uncrewed sub-surface water borne vehicle, a satellite, and combinations thereof.

19. The method of claim 13, further comprising:
detecting a subsequent fire threat condition at a subsequent fire threat location within the structure, said subsequent fire threat condition detected by the at least one fire threat detector type, said at least one fire threat detector type configured to send a subsequent fire threat signal to the at least one of the system processor and the controller, said system processor in communication with at least one controller, said at least one controller in communication with at least two of the plurality of fire suppressant types, each of said at least two fire suppressant types housed within an associated fire suppressant type supply,
determining the subsequent fire threat location within the structure, said structure comprising at least one contained environment;
sending a subsequent fire threat condition signal from the detector to at least one of the system processor and the at least one system controller;
selecting at least one of the plurality of fire suppressant types to form a selected fire suppressant type, said selecting in response to the subsequent fire threat condition detected by the at least one fire threat detector type;
releasing a selected amount of the selected fire suppressant type from a selected fire suppressant type supply to form a selected fire suppressant type flow in response to the subsequent fire threat signal;
directing the selected fire suppressant type flow to at least one fire suppressant delivery device, said fire suppressant delivery device located proximate to the subsequent fire threat location;
releasing the selected fire suppressant type flow from the at least one fire suppressant delivery device, said fire suppressant delivery device located proximate to the subsequent fire threat location; and
directing the selected fire suppressant type flow to the subsequent fire threat location.

20. The method of claim 19, further comprising:
delivering concurrently at least one of the plurality of fire suppressant types to at least one of the first fire threat location and the subsequent fire threat location, said plurality of fire suppressant types each comprising a different fire suppressant type in response to at least one of the first fire threat signal and the subsequent fire threat signal.

21. The method of claim 19, further comprising:
delivering sequentially at least one of the plurality of fire suppressant types to at least one of the first fire threat location and the subsequent fire threat location, said plurality of fire suppressant types each comprising a different fire suppressant type, said different fire suppressant type selected in response to at least one of the first fire threat signal and the subsequent fire threat signal.

22. The method of claim 19, wherein the structure is selected from the group consisting of: a vehicle and a building.

23. The method of claim 22, wherein the vehicle is selected from the group consisting of:
a crewed aircraft, an uncrewed aircraft, a crewed spacecraft, an uncrewed spacecraft, a crewed rotorcraft, an uncrewed rotorcraft, a crewed terrestrial vehicle, an uncrewed terrestrial vehicle, a crewed surface water borne vehicle, an uncrewed waterborne vehicle, a crewed sub-surface water borne vehicle, an uncrewed sub-surface water borne vehicle, a satellite, and combinations thereof.
